(19) United States
(12) Patent Application Publication
(10) Pub. No.: US 2006/0121227 A1
(43) Pub. Date: Jun. 8, 2006

(54) Pipe having barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/181,268

(22) Filed: Jul. 14, 2005

(30) Foreign Application Priority Data
Dec. 7, 2004 (KR) 10-2004-0102212
Jun. 2, 2005 (KR) 10-2005-0047114

(51) Int. Cl. B32B 1/08

(52) U.S. Cl. 428/36.9

(57) ABSTRACT

A pipe having barrier properties is provided. The pipe prepared by molding a dry-blended composition including a polyolefin resin, a nanocomposite having barrier properties, a compatibilizer, and a reinforcing agent has superior barrier properties, and thus is usable as a filler pipe for automobiles, an air conditioner pipe, etc.

### BACKGROUND OF THE INVENTION

This application claims the benefit of Korean Patent Application No. 10-2004-0102212, filed on Dec. 7, 2004, and Korean Patent Application No. 10-2005-0047114, filed on Jun. 2, 2005,in the Korean Intellectual Property Office, the disclosures of which are incorporated herein in their entirety by reference.

1. Field of the Invention

The present invention relates to a pipe having barrier properties, prepared from a dry-blended composition including a polyolefin resin, a nanocomposite of an intercalated clay and a resin having barrier properties, a compatibilizer, and a reinforcing agent.

2. Description of the Related Art

A hot-water circulation pipe, a filler pipe for automobiles, an air conditioner pipe, a gas pipe, etc. need a gas barrier property, an oxygen barrier property and moisture proof property to prevent the leakage of air and gas therein.

A hot-water circulation pipe composed of a metallic material is conventionally used in a floor heating system using hot-water circulation. The hot-water circulation pipe is mainly installed below a floor by being embedded in concrete. Once installed, subsequent repair is difficult and a lifespan of over 50 years is required. Under these strict requirements, it is preferable to use a plastic pipe which does not corrode and is inexpensive compared to the metallic pipe. For the plastic pipe, polyethylene, polypropylene, polybutene, etc. are used. However, when the plastic pipe is used in the floor heating system using hot-water circulation, a metallic connection portion of a heat exchanger or a pump with the pipe is corroded by oxygen. Corrosion occurs since oxygen in the air passes through a plastic wall to permeate into and be dissolved in the hot water circulating through the pipes. Thus, a multi-layered polyethylene pipe (PE/aluminum layer/PE) is used, but it does not prevent the corrosion due to oxygen since a crack in the aluminum layer is caused by a change in temperature. To solve this problem, various multi-layered pipes composed of a plastic resin having a good oxygen barrier property and polyethylene are being examined. A multi-layered pipe using an ethylene-vinyl alcohol (EVOH) copolymer is identified to have a superior oxygen barrier property and mechanical strength and is commonly used as a hot-water circulation pipe nowadays. However, while EVOH has a good oxygen barrier property and mechanical strength, it has insufficient crack-resistance due to its stiffness.

Meanwhile, in the case of a filler pipe for automobiles, for example, a co-extrusion blow-molded plastic pipe is advantageously used to supply gasoline. For the plastic pipe, polyethylene is conventionally used due to its cost, good moldability and mechanical strength. However, polyethylene has poor barrier properties so that gasoline vapor or liquid in the pipe easily evaporates through the polyethylene wall.

To overcome these drawbacks, a multi-layered pipe of an EVOH copolymer having good barrier properties and a polyethylene resin is used, which does not always have satisfactory barrier properties as well. Economization in gasoline and environmental protection are recent trends, and thus, a reduction in permeation of gasoline though a fuel pipe is required.

Meanwhile, when a nano-sized intercalated clay is mixed with a polymer compound to form a fully exfoliated, partially exfoliated, intercalated, or partially intercalated nanocomposite, it has improved barrier properties due to its morphology. Thus, an article having barrier properties using such a nanocomposite is emerging.

### SUMMARY OF THE INVENTION

The present invention provides a pipe having superior barrier properties and crack-resistance by using a nanocomposite having barrier properties.

According to an aspect of the present invention, there is provided a pipe having barrier properties prepared by molding a dry-blended composition including: 40 to 98 parts by weight of a polyolefin resin; 0.5 to 60 parts by weight of a nanocomposite having barrier properties, including an intercalated clay and at least one resin having barrier properties, selected from the group consisting of an ethylene-vinyl alcohol (EVOH) copolymer, a polyamide, an ionomer, and a polyvinyl alcohol (PVA); 1 to 30 parts by weight of a compatibilizer; and 1 to 10 parts by weight of at least one reinforcing agent selected from the group consisting of a low density polyethylene (LDPE), a linear low density polyethylene (LLDPE), a very low density polyethylene (VLDPE) and a rubber.

In an embodiment of the present invention, the polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, a flame retardant, etc. to a homopolymer or copolymer of propylene.

In another embodiment of the present invention, the intercalated clay may be at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one compound selected from an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer.

In another embodiment of the present invention, the pipe may be a single-layered product or multi-layered product.

In another embodiment of the present invention, the pipe may be a filler pipe for automobiles, an air conditioner pipe, a water supplying pipe, a drain pipe, a hot-water circulation pipe, or a gas pipe.

### DETAILED DESCRIPTION OF THE INVENTION

The present invention will now be explained in more detail.

A pipe having barrier properties according to an embodiment of the present invention is prepared by molding a dry-blended composition including: 40 to 98 parts by weight of a polyolefin resin; 0.5 to 60 parts by weight of a nanocomposite having barrier properties, including an intercalated clay and at least one resin having barrier properties, selected from the group consisting of an ethylene-vinyl alcohol (EVOH) copolymer, a polyamide, an ionomer, and a polyvinyl alcohol (PVA); 1 to 30 parts by weight of a compatibilizer; and 1 to 10 parts by weight of at least one reinforcing agent selected from the group consisting of a low density polyethylene (LDPE), a linear low density polyethylene (LLDPE), a very low density polyethylene (VLDPE) and a rubber.

The polyolefin resin may include at least one compound selected from the group consisting of a HDPE, a LDPE, a LLDPE, an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, a flame retardant, etc. to a homopolymer or copolymer of propylene.

The content of the polyolefin resin is preferably 40 to 98 parts by weight, and more preferably 65 to 96 parts by weight. If the content of the polyolefin resin is less than 40 parts by weight, molding is difficult. If the content of the polyolefin resin is greater than 98 parts by weight, the barrier property is poor.

The nanocomposite having barrier properties may be prepared by mixing an intercalated clay with at least one resin having barrier properties, selected from the group consisting of an EVOH copolymer, a polyamide, an ionomer and a polyvinyl alcohol (PVA).

The weight ratio of the resin having barrier properties to the intercalated clay in the nanocomposite is 58.0:42.0 to 99.9:0.1, and preferably 85.0:15.0 to 99.0:1.0. If the weight ratio of the resin having barrier properties to the intercalated clay is less than 58.0:42.0, the intercalated clay agglomerates and dispersing is difficult. If the weight ratio of the resin having barrier properties to the intercalated clay is greater than 99.9:0.1, the improvement in the barrier properties is negligible.

The intercalated clay is preferably organic intercalated clay. The content of an organic material in the intercalated clay is preferably 1 to 45 wt %. When the content of the organic material is less than 1 wt %, compatibility of the intercalated clay and the resin having barrier properties is poor. When the content of the organic material is greater than 45 wt %, intercalation of the resin having barrier properties becomes more difficult.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, oxazoline, and dimethyidistearylammonium.

If an EVOH copolymer is included in the nanocomposite, the content of ethylene in the EVOH copolymer is preferably 10 to 50 mol %. If the content of ethylene is less than 10 mol %, melt molding becomes more difficult due to poor processability. If the content of ethylene exceeds 50 mol %, the oxygen and liquid barrier properties are insufficient.

If a polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

The amorphous polyamide refers to a polyamide having insufficient crystallinity, that is, not having an endothermic crystalline melting peak when measured by a differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1,5-diaminopentane, 1,4-diaminobutane, 1,3-diaminopropane, 2-ethyidiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using aliphatic diamine and aliphatic dicarboxylic acid is general semicrystalline polyamide (also referred to as crystalline nylon) and is not an amorphous polyamide. Polyamide prepared using aromatic diamine and aromatic dicarboxylic acid is not easily treated using a general melting process.

Thus, amorphous polyamide is preferably prepared, when one of diamine and dicarboxylic acid used is aromatic and the other is aliphatic. Aliphatic groups of the amorphous polyamide are preferably C₁-C₁₅ aliphatic or C₄-C₈-alicyclic alkyls. Aromatic groups of the amorphous polyamide are preferably substituted C₁-C₆ mono- or bicyclic aromatic groups. However, all the above amorphous polyamide is not preferable in the present invention. For example, metaxylenediamine adipamide is easily crystallized when heated during a thermal molding process or when oriented, therefore, it is not preferable.

Examples of preferable amorphous polyamides include hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, a copolymer of hexamethylenediamine or 2-methylpentamethylenediamine and an isophthalic acid, terephthalic acid or mixtures thereof. While polyamide based on hexamethylenediamine isophthalamide/terephthalamide, which has a high terephthalic acid content, is useful, it should be mixed with another diamine such as 2-methyldiaminopentane in order to produce an amorphous polyamide that can be processed.

The above amorphous polyamide comprising only the above monomers may contain a small amount of lactam, such as caprolactam or lauryl lactam, as a comonomer. It is important that the polyamide be amorphous. Therefore, any comonomer that does not crystallize polyamide can be used. About 10 wt % or less of a liquid or solid plasticizer, such as glycerole, sorbitol, or toluenesulfoneamide (Santicizer 8 monsanto) can also be included in the amorphous polyamide. For most applications, a glass transition temperature Tg (measured in a dried state, i.e., with a water content of about 0.12 wt % or less) of amorphous polyamide is about 70-170° C., and preferably about 80-160° C. The amorphous polyamide, which is not blended, has a Tg of approximately 125° C. in a dried state. The lower limit of Tg is not clear, but 70° C. is an approximate lower limit. The upper limit of Tg is not clear, either. However, when polyamide with a Tg of about 170° C. or greater is used, thermal molding is difficult. Therefore, polyamide having both an acid and an amine having aromatic groups cannot be thermally molded due to an excessively high Tg, and thus, is not suitable for the purposes of the present invention.

The polyamide may also be a semicrystalline polyamide. The semicrystalline polyamide is generally prepared using lactam, such as nylon 6 or nylon 11, or an amino acid, or is prepared by condensing diamine, such as hexamethylenediamine, with dibasic acid, such as succinic acid, adipic acid, or sebacic acid. The polyamide may be a copolymer or a terpolymer, such as a copolymer of hexamethylenediamine/adipic acid and caprolactam (nylon 6, 66). A mixture of two or more crystalline polyamides can also be used. The semicrystalline and amorphous polyamides are prepared by condensation polymerization well-known in the art.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably, 4 to 30 parts by weight. If the content of the nanocomposite is less than 0.5 part by weight, an improvement of barrier properties is negligible. If the content of the nanocomposite is greater than 60 parts by weight, processing becomes more difficult and the physical properties of a molded article are poor.

The finer the intercalated clay is exfoliated in the resin having barrier properties in the nanocomposite, the better the barrier properties that can be obtained. This is because the exfoliated intercalated clay forms a barrier film and thereby improves barrier properties and mechanical properties of the resin itself, and ultimately improves the barrier properties and mechanical properties of a molded article prepared from the composition. Accordingly, the ability to form a barrier to gas and liquid is maximized by compounding the resin having barrier properties and the intercalated clay, and dispersing the nano-sized intercalated clay in the resin, thereby maximizing the contact area of the polymer chain and the intercalated clay.

The compatibilizer improves the compatibility of the polyolefin resin with the nanocomposite to form a molded article with a stable structure.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite having barrier properties, thereby obtaining a molded article with a stable structure.

The compatibilizer can include at least one compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

The content of the compatibilizer is preferably 1 to 30 parts by weight, and more preferably 2 to 15 parts by weight. If the content of the compatibilizer is less than 1 part by weight, the mechanical properties of a molded article from the composition are poor. If the content of the compatibilizer is greater than 30 parts by weight, molding of the composition becomes more difficult.

When an epoxy-modified polystyrene copolymer is used as the compatibilizer, a copolymer comprising a main chain which comprises 70 to 99 parts by weight of styrene and 1 to 30 part by weight of an epoxy compound represented by Formula 1, and branches which comprise 1 to 80 parts by weight of acrylic monomers represented by Formula 2, is preferable.

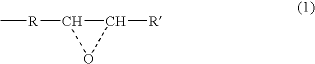

where each of R and R′ is independently a C₁-C₂₀ aliphatic residue or a C₅-C₂₀ aromatic residue having double bonds at its termini

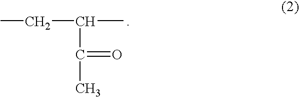

Each of the maleic anhydride modified (graft) high-density polyethylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the main chain. When the content of the maleic anhydride is less than 0.1 part by weight, it does not function as the compatibilizer. When the content of the maleic anhydride is greater than 10 parts by weight, an unpleasant odor appears.

The reinforcing agent may be at least one material selected from LDPE, VLDPE, LLDPE, and a rubber. The rubber usable as the reinforcing agent includes conjugated diene (co)polymers, such as polybutadiene, polyisoprene, butadiene-isoprene copolymer, polychloroprene, styrene-butadiene copolymer, acrylonitrile-butadiene copolymer, and acrylate-butadiene copolymer; hydrides of the conjugated diene (co)polymers; olefinic rubber, such as ethylene-propylene copolymer; acrylic rubber, such as polyacrylate; polyorganosiloxane; thermoplastic elastomer; ethylene-based ionomer copolymer. These materials may be used alone or in a combination of two or more. Among these materials, acrylic rubber, conjugated diene polymers or hydrides of the conjugated diene polymers are preferable.

The acrylic rubber or conjugated diene polymer is prepared by polymerizing alkyl acrylate or a conjugated diene compound as a monomer. The acrylic rubber or conjugated diene polymer may be prepared by copolymerizing said monomers and another monofunctional polymerizable monomer, if necessary. Examples of the monofunctional polymerizable monomer include methacrylates, such as methyl methacrylate, ethyl methacrylate, propyl methacrylate, octyl methacrylate, decyl methacrylate, dodecyl methacrylate, octadecyl methacrylate, phenyl methacrylate, benzyl methacrylate, naphthyl methacrylate, and isobornyl methacrylate; aromatic compounds, such as styrene and α-methylstyrene; acrylonitrile, etc. The content of the monofunctional polymerizable monomer is preferably 20 wt % or less of the whole polymerizable monomers for forming a rubber.

The content of the reinforcing agent is 1 to 10 parts by weight. When the content of the reinforcing agent is less than 1 part by weight, the effects of reinforcing physical properties cannot be obtained. When the content of the reinforcing agent is greater than 10 parts by weight, the elasticity of a product increases and distortion may be caused by internal pressure.

The dry-blended composition of the present invention is prepared by simultaneously introducing the pelleted nanocomposite having barrier properties, the compatibilizer, the polyolefin resin and the reinforcing agent at a constant compositional ratio in a pellet mixer and mixing them.

A pipe having barrier properties according to the present invention is obtained by molding the dry-blended composition.

In the present invention, general molding methods including extrusion molding, pressure molding, blow molding and injection molding can be used.

While the pipe having barrier properties of the present invention can be a single-layered molded article composed of the nanocomposite, composition, a multi-layered product having the nanocomposite composition layer and another thermoplastic resin layer is preferable. The resin suitable for the thermoplastic resin layer includes high-, middle- or low-density polyethylene, a copolymer of ethylene and vinyl acetate, acrylate or α-olefin, such as butene or hexene, an ionomer resin, a homopolymer of propylene, a copolymer of propylene and α-olefin, polyolefins, such as a polypropylene modified with a rubber polymer, or maleic anhydride added or grafted resins thereof. The resin for the thermoplastic resin layer may also be a polyamide resin, a polyester resin, a polystyrene resin, a polyvinyl chloride resin, an acrylic resin, a polyurethane resin, a polycarbonate resin, a polyvinyl acetate resin, etc.

In the multi-layered pipe, an adhesive resin layer may be interposed between the nanocomposite composition layer and the thermoplastic resin layer. The adhesive resin may be unsaturated carboxylic acid or its anhydride (maleic anhydride, etc.) grafted olefin polymer or copolymer (ex. LLDPE, VLDPE, etc.), ethylene-vinyl acetate copolymer or ethylene-(meth)acrylate copolymer.

A method of manufacturing the pipe of the present invention is not particularly restricted. For example, an endless pipe can be most efficiently obtained by co-extrusion molding the composition using 2 or 3 extruders and a circular die for multi-layer.

The layer structure of the multi-layered pipe is not particularly restricted, either. In consideration of moldability, costs, etc., the structures such as thermoplastic resin layer/nanocomposite composition layer/thermoplatic resin layer, nanocomposite composition layer/adhesive resin layer/thermoplatic resin layer, thermoplastic resin layer/adhesive resin layer/nanocomposite composition layer/adhesive resin layer/thermoplastic resin layer, etc. sequentially from outside to inside may be formed. When the thermoplastic resin layers are formed as the most outer and inner layers, they may be identical or different. The structure of nanocomposite composition layer/adhesive resin layer/thermoplastic resin layer is preferable. In consideration of gas barrier properties, it is particularly preferable to form the nanocomposite composition layer as the outer-most layer of the pipe. However, a conventional EVOH multi-layered pipe has a poor appearance and barrier properties due to poor crack resistance even when a resin having gas barrier properties is used in the outer-most layer, and thus its value as a hot-water circulation pipe is considerably decreased. Meanwhile, since the nanocomposite composition of the present invention has good gas barrier properties and crack resistance, a multi-layered pipe for hot-water circulation can be provided even when it is used in the outer-most layer.

The single-layered and multi-layered pipes having barrier properties have good gas barrier properties and crack resistance, and thus they can be used as a hot-water circulation pipe. Also, they can be used as pipes for various liquids or gases.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 500 (KP Chemicals)

HDPE-g-MAH: Compatibilizer, PB3009 (CRAMPTON)

HDPE: RT DX800 (SK Chemicals)

Clay: Closite 30B (SCP)

Thermal stabilizer: IR 1098 (Songwon Inc.)

Adhesive resin: AB130 (HDPE-g-MAH, LG CHEM)

Reinforcing agent: EG8180 (ethylene octane copolymer)-Dupont-DOW

### Preparation Example 1

### Preparation of EVOH/Intercalated Clay Nanocomposite

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; Φ 40). Then, 3 wt % of organic montmorillonite (Southern Intercalated Clay Products, USA C20A) as an intercalated clay and 0.1 part by weight of IR 1098 as a thermal stabilizer based on total 100 parts by weight of the EVOH copolymer and the organic montmorillonite was separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 15 kg/hr.

### Preparation Example 2

### Preparation of Nylon 6/Intercalated Clay Nanocomposite

97 wt % of a polyamide (nylon 6) was put in the main hopper of a twin screw extruder (SM Platek co-rotation twin screw extruder; Φ 40). Then, 3 wt % of organic montmorillonite as an intercalated clay and 0.1 part by weight of IR 1098 as a thermal stabilizer based on total 100 parts by weight of the polyamide and the organic montmorillonite was separately put in the side feeder of the twin screw extruder to prepare a polyamide/intercalated clay nanocomposite in a pellet form. The extrusion temperature condition was 220-225-245-245-245-245-245° C., the screws were rotated at 300 rpm, and the discharge condition was 40 kg/hr.

### Example 1

15 parts by weight of the EVOH/intercalated clay nanocomposite obtained in the Preparation Example 1, 10 parts by weight of a compatibilizer, 72 parts by weight of HDPE and 3 parts by weight of a reinforcing agent were dry-blended in a double cone mixer (MYDCM-100) and put in the main hopper of a single screw extruder (Goetffert Φ 45, L/D: 23) to manufacture a single-layered pipe with an outer diameter of 30 mm. The extrusion temperature condition was 190-210-210-210-210° C., the screw was rotated at 20 rpm, and the discharge condition was 6 kg/hr.

### Example 2

15 parts by weight of the nylon 6/intercalated clay nanocomposite obtained in the Preparation Example 2, 10 parts by weight of a compatibilizer, 72 parts by weight of HDPE and 3 parts by weight of a reinforcing agent were dry-blended in a double cone mixer (MYDCM-1 00) and put in the main hopper of a single screw extruder (Goetffert Φ 45) to manufacture a single-layered pipe with an outer diameter of 30 mm. The extrusion temperature condition was 210-220-220-220-220° C. and the screw was rotated at 20 rpm.

### Example 3

15 parts by weight of the nylon 6/intercalated clay nanocomposite obtained in the Preparation Example 2, 10 parts by weight of a compatibilizer, 72 parts by weight of HDPE, and 3 parts by weight of a reinforcing agent were dry-blended and simultaneously put in the main hopper of a single screw extruder (Goetffert φ 45) through belt-type feeders (K-TRON Nos. 1, 2, 3 and 4), respectively, to manufacture a single-layered pipe with an outer diameter of 30 mm. The extrusion temperature condition was 210-220-220-220-220° C. and the screw was rotated at 20 rpm.

### Example 4

15 parts by weight of the EVOH/intercalated clay nanocomposite obtained in the Preparation Example 1, 10 parts by weight of a compatibilizer, 72 parts by weight of HDPE and 3 parts by weight of a reinforcing agent were dry-blended in a tumble mixer. Then, the mixture was put in the outside layer extruder of a 3-layer extruder, HDPE was put in the inside layer extruder, and an adhesive resin was put in the middle layer extruder to manufacture a multi-layered pipe with an outer diameter of 30 mm.

### Example 5

4 parts by weight of the nylon 6/intercalated clay nanocomposite obtained in the Preparation Example 2, 2 parts by weight of a compatibilizer, 93 parts by weight of HDPE and 1 part by weight of a reinforcing agent were dry-blended in a tumble mixer. Then, the mixture was put in the outside layer extruder of a 3-layer extruder, HDPE was put in the inside layer extruder, and an adhesive resin was put in the middle layer extruder to manufacture a multi-layered pipe with an outer diameter of 30 mm.

### Example 6

15 parts by weight of the nylon 6/intercalated clay nanocomposite obtained in the Preparation Example 2, 10 parts by weight of a compatibilizer, 72 parts by weight of HDPE and 3 parts by weight of a reinforcing agent were dry-blended in a tumble mixer. Then, the mixture was put in the outside layer extruder of a 3-layer extruder, HDPE was put in the inside layer extruder, and an adhesive resin was put in the middle layer extruder to manufacture a multi-layered pipe with an outer diameter of 30 mm.

### Example 7

34 parts by weight of the nylon 6/intercalated clay nanocomposite obtained in the Preparation Example 2, 18 parts by weight of a compatibilizer, 40 parts by weight of HDPE and 8 parts by weight of a reinforcing agent were dry-blended in a tumble mixer. Then, the mixture was put in the outside layer extruder of a 3-layer extruder, HDPE was put in the inside layer extruder, and an adhesive resin was put in the middle layer extruder to manufacture a multi-layered pipe with an outer diameter of 30 mm.

### Comparative Example 1

100 wt % of HDPE was extruded to manufacture a single-layered pipe.

### Comparative Example 2

A pipe was manufactured in the same manner as in Example 1, except that the intercalated clay was not used.

### Comparative Example 3

A pipe was manufactured in the same manner as in Example 2, except that the intercalated clay was not used.

### Comparative Example 4

EVOH was put in the outside layer extruder of a 3-layer extruder, HDPE was put in the inside layer extruder, and an adhesive resin was put in the middle layer extruder to manufacture a multi-layered pipe with an outer diameter of 30 mm.

For the obtained pipes, an oxygen barrier property and crack resistance were evaluated as follows.

Oxygen Barrier Property

The oxygen barrier property is evaluated by the rate of increase in dissolved oxygen (DO). If the rate of increase in DO is lower, the oxygen barrier property is better. Water from which oxygen had been removed using a packed tower containing metal tin was allowed to circulate in pipes obtained in the above Examples and Comparative Examples. The rate of increase in DO was measured at 20° C. under the condition of 65% RH. The rate of increase is represented as μg/hr and indicates that oxygen dissolved in 1 L of water in the pipe is increased at a rate of μg/hr. That is, when the volume of water in the whole system including the pipe is V1 cc, the volume of water in the pipe is V2 cc, and the rate of increase in an oxygen concentration in the circulating water in the apparatus per 1 hour is B μg/hr, the rate of increase in DO, A μg/hr, is obtained by the equation of A=B(V1/V2).

Crack Resistance

The obtained pipes were cut into 20 cm and let alone in an incubator at −15° C. for 10 min. Then, the pipes were slowly four fold enlarged with a metallic enlarger having 4 nail-shaped components until the internal diameter of the pipes was 45 mm. The occurrence of cracks in the resin layer was identified with the naked eye. This test was performed on 100 pipe samples and occurrence frequency (occurrence rate) of cracks was evaluated as follows:

A: No cracks

B: Fine cracks (0.5 mm or less)

C: Fine cracks and large cracks (0.5 mm or greater)

D: Only large cracks

TABLE 1
Oxygen barrier property (μg/hr)

| | | | | | | | Comparative | Comparative | Comparative | Comparative |
|---|---|---|---|---|---|---|---|---|---|---|
| Ex. 1 | Ex. 2 | Ex. 3 | Ex. 4 | Ex. 5 | Ex. 6 | Ex. 7 | Ex. 1 | Ex. 2 | Ex. 3 | Ex. 4 |
| 48 | 29 | 31 | 76 | 74 | 44 | 27 | 813 | 292 | 308 | 41 |

TABLE 2
Crack resistance

| | | | | | | | | Comparative | Comparative | Comparative | Comparative |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 1 | Ex. 2 | Ex. 3 | Ex. 4 |
| A | 46 | 96 | 95 | 82 | 100 | 100 | 100 | 100 | 0 | 96 | 0 |
| B | 32 | 4 | 5 | 18 | 0 | 0 | 0 | 0 | 41 | 4 | 0 |
| C | 12 | 0 | 0 | 0 | 0 | 0 | 0 | 0 | 45 | 0 | 6 |
| D | 0 | 0 | 0 | 0 | 0 | 0 | 0 | 0 | 14 | 0 | 94 |

As shown in Tables 1 and 2, pipes of Examples 1 to 7 have a superior barrier property and crack resistance than those of Comparative Examples 1 to 4.

The pipe of the present invention has superior barrier properties, and thus is effectively used as a filler pipe for automobiles, an air conditioner pipe, an LNG supply pipe, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A pipe having barrier properties prepared by molding a dry-blended composition comprising:
40 to 98 parts by weight of a polyolefin resin;
0.5 to 60 parts by weight of a nanocomposite having barrier properties, including an intercalated clay and at least one resin having barrier properties, selected from the group consisting of an ethylene-vinyl alcohol (EVOH) copolymer, a polyamide, an ionomer, and a polyvinyl alcohol (PVA);
1 to 30 parts by weight of a compatibilizer; and
1 to 10 parts by weight of at least one reinforcing agent selected from the group consisting of a low density polyethylene (LDPE), a linear low density polyethylene (LLDPE), a very low density polyethylene (VLDPE) and a rubber.

2. The pipe having barrier properties of claim 1, wherein the polyolefin resin is at least one compound selected from the group consisting of a high density polyethylene (HDPE), a low density polyethylene (LDPE), a linear low density polyethylene (LLDPE), an ethylene-propylene copolymer, metallocene polyethylene, and polypropylene.

3. The pipe having barrier properties of claim 2, wherein the polypropylene is at least one compound selected from the group consisting of a homopolymer or copolymer of propylene, metallocene polypropylene, and a composite resin prepared by adding talc or a flame retardant to the homopolymer or copolymer of propylene.

4. The pipe having barrier properties of claim 1, wherein the weight ratio of the resin having barrier properties to the intercalated clay in the nanocomposite is 58.0:42.0 to 99.9:0.1.

5. The pipe having barrier properties of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

6. The pipe having barrier properties of claim 1, wherein the intercalated clay comprises 1 to 45 wt % of an organic material.

7. The pipe having barrier properties of claim 6, wherein the organic material has at least one functional group selected from the group consisting of primary ammonium to quaternary ammonium, phosphonium, maleate, succinate, acrylate, benzylic hydrogen, oxazoline, and dimethyldistearylammonium.

8. The pipe having barrier properties of claim 1, wherein the ethylene-vinyl alcohol copolymer contains 10 to 50 mol % of ethylene.

9. The pipe having barrier properties of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

10. The pipe having barrier properties of claim 9, wherein the glass transition temperature of the amorphous polyamide is about 70-170° C.

11. The pipe having barrier properties of claim 9, wherein the amorphous polyamide is selected from the group consisting of hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, and a copolymer of hexamethylenediamine or 2-methylpentamethylenediamine and isophthalic acid, terephthalic acid, or a mixture thereof.

12. The pipe having barrier properties of claim 11, wherein the amorphous polyamide is hexamethylene diamine isophthalamide/terephthalamide terpolymer having a ratio of isophthalic acid to terephthalic acid of about 70:30.

13. The pipe having barrier properties of claim 1, wherein the ionomer has a melt index of 0.1 to 10 g/10 min (190° C., 2,160 g).

14. The pipe having barrier properties of claim 1, wherein the rubber is at least one material selected from the group consisting of conjugated diene (co)polymers, hydrides of the conjugated diene (co)polymers, olefinic rubber, acrylic rubber, polyorganosiloxane, thermoplastic elastomer and ethylene ionomer copolymer.

15. The pipe having barrier properties of claim 1, wherein the compatibilizer is one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

16. The pipe having barrier properties of claim 1, prepared by extrusion molding, pressure molding, blow molding, or injection molding.

17. The pipe having barrier properties of claim 1, having a single-layered structure or a multi-layered structure.

18. The pipe having barrier properties of claim 1, which is a hot water circulation pipe, a filler pipe for automobiles, an air conditioner pipe, or an LNG supply pipe.
